(19) United States
(12) Patent Application Publication
(10) Pub. No.: US 2010/0053062 A1
(43) Pub. Date: Mar. 4, 2010

(54) INTELLIGENT ROW- AND MULTICOLOR BACKLIGHT-MODULATION LCD DEVICE AND A METHOD THEREOF

(76) Inventors: Shyh-Yueh WANG, Taichung (TW); Chuen-Tzay Jean, Taichung City (TW); Chia-Hui Chen, Taichung County (TW); Chiu-Yuan Huang, Taichung City (TW); Yen-Liang Chen, Taichung County (TW); Wei-Jen Tang, Taichung City (TW); Chien-Chih Hsu, Changhua County (TW)

Correspondence Address: Muncy, Geissler, Olds & Lowe, PLLC, P.O. BOX 1364, FAIRFAX, VA, 22038-1364, US

(21) Appl. No.: 12/203,711

(22) Filed: Sep. 3, 2008

(51) Int. Cl. G09G 3/36

(52) U.S. Cl. 345/102

(57) ABSTRACT

The present invention discloses a single-level driver is programmed to generate a plurality of segment voltage signals. A multicolor backlight modulation device receives the segment voltage signals and modulating a portion of the segment voltage signals to generate a common voltage signal and at least two synchronous color-separation backlight driving signals driving a backlight source to emitting different-color backlights. The common voltage signal cooperates with the segment voltage signals to form voltage differences which drive a mono-pixel to turn on or turn off in a time-division mode and allow different-color backlights to pass the mono-pixel at the same time. The time-division different-color backlights are accumulated by vision persistence to present a chromatic effect on the mono-pixel. The resultant colors can be intelligently varied via programming the segment voltage signals to achieve diversified multicolor effects. Therefore, the present invention can enable mono-pixels to present multicolor effect with a single-level display chip.

### FIELD OF THE INVENTION

The present invention relates to an LCD device and a method thereof, particularly to an LCD device and a method thereof, which intelligently enable a monochromatic LCD panel and a single-level driver to present multicolor effect without using a color filter.

### BACKGROUND OF THE INVENTION

The conventional LCD (Liquid Crystal Display) device needs a color filter to generate colors. The white light generated by a backlight device passes through the R/G/B (red/green/blue) subpixels to generate the three primary colors. Then, the three primary colors are mixed by different ratios in different pixels to present various colors.

As white light passes through the RGB subpixels of a color filter, most of the backlight is filtered out. Therefore, the prior art has low backlight efficiency, low color saturation and high cost.

### SUMMARY OF THE INVENTION

The primary objective of the present invention is to provide a filter-free LCD (Liquid Crystal Display) device and a method thereof, which has a higher light efficiency and a lower price.

The device of the present invention comprises a monochromatic LCD panel, a single-level driver, a multicolor backlight modulation device, and a multicolor modulation backlight unit. The monochromatic LCD panel has a common electrode and a plurality of segment electrodes, and the common electrode and the segment electrodes are respectively arranged on an upper layer and a lower layer. The multicolor modulation backlight unit has a backlight source emitting at least two different-color backlights. The single-level driver is programmed to generate a plurality of segment voltage signals. The multicolor backlight modulation device receives the segment voltage signals and modulates a portion of the segment voltage signals to generate a common voltage signal and a plurality of synchronous color-separation backlight driving signals, wherein the number of the color-separation backlight driving signals is equal to the number of the backlights. The color-separation backlight driving signals are used to drive the multicolor modulation backlight unit, and the common voltage signal and the segment voltage signals are respectively input to the common electrode and the segment electrodes.

Then, the common voltage signal cooperates with the segment voltage signals to form voltage differences. The voltage differences drive a mono-pixel to turn on or turn off in a time-division mode. At the same time, the color-separation backlight driving signals drive the backlight source to turn on or turn off at least two different-color backlights. The time-division different-color backlights are accumulated by vision persistence to present a multicolor effect on the mono-pixel.

### BRIEF DESCRIPTION OF THE DRAWINGS

FIG. 1 is a diagram schematically showing the electrodes of a monochromatic LCD panel according to the present invention;

FIG. 2 is a diagram schematically showing an LCD device according to the present invention;

FIG. 3 is a diagram schematically showing a multicolor modulation backlight unit according to the present invention;

FIG. 4 is a diagram showing the segment voltage signals generated by a programmable single-level driver according to the present invention; and

FIG. 5 is a diagram showing the voltage signals output by a multicolor backlight modulation device according to the present invention.

### DETAILED DESCRIPTION OF THE PREFERRED EMBODIMENTS

Below, the technical contents of the present invention are described in detail in cooperation with the drawings.

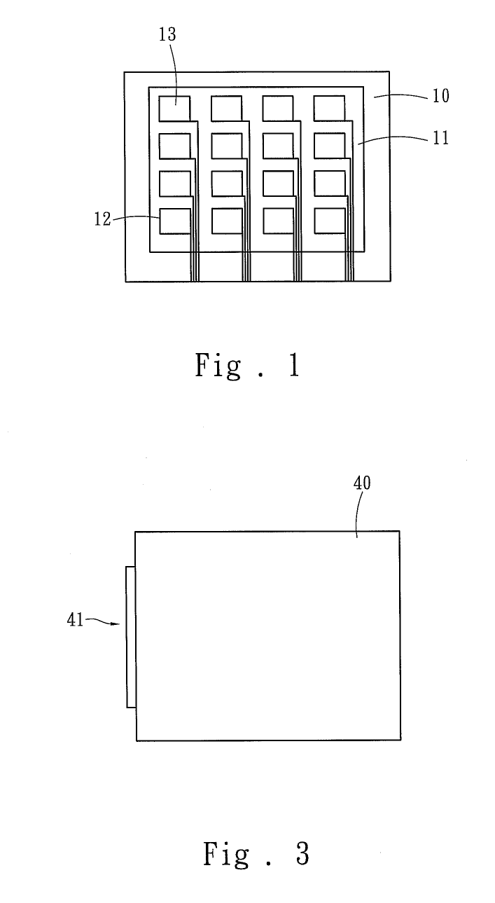

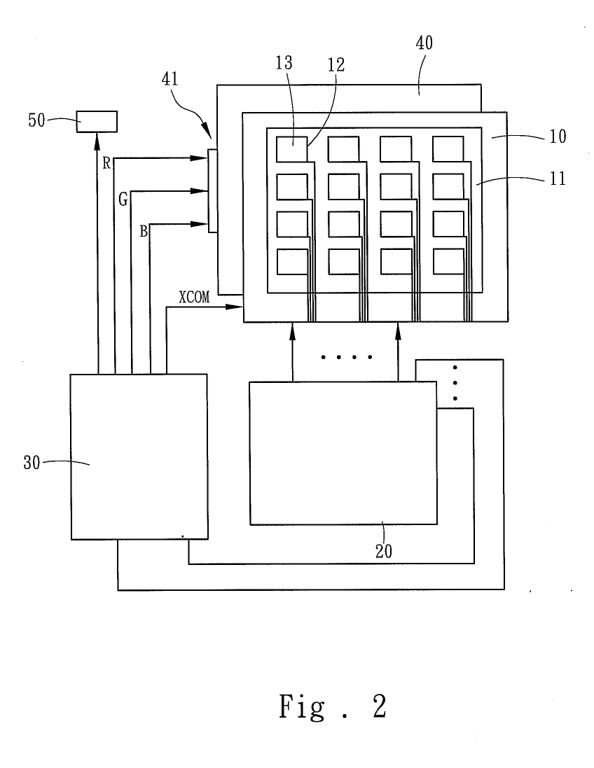

Refer to FIG. 1, FIG. 2 and FIG. 3. The device of the present invention comprises a monochromatic LCD (Liquid Crystal Display) panel 10, a single-level driver 20, a multicolor backlight modulation device 30, and a multicolor modulation backlight unit 40. The monochromatic LCD panel 10 has a common electrode 11 and a plurality of segment electrodes 12, and the common electrode 11 and the segment electrodes 12 are respectively arranged on an upper layer and a lower layer. The monochromatic LCD panel 10 also has a plurality of mono-pixels 13 corresponding to the coincidence points of the common electrode 11 and the segment electrodes 12. In FIG. 1, the monochromatic LCD panel 10 has 16 mono-pixels 13. The multicolor modulation backlight unit 40 has a backlight source 41 emitting at least two different-color backlights, preferably red, green and blue backlights.

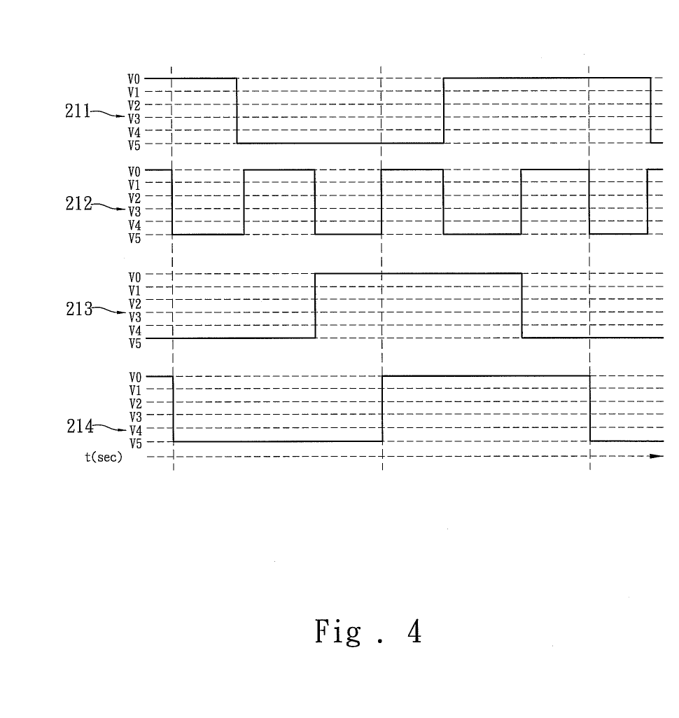

Refer to FIG. 4 also. The single-level driver 20 sequentially generates a plurality of segment voltage signals according to the timing. The segment voltage signals are programmable with software. As shown in the drawing, the single-level driver 20 are programmed to generate a first segment voltage signal 211, a second segment voltage signal 212, a third segment voltage signal 213 and a fourth segment voltage signal 214.

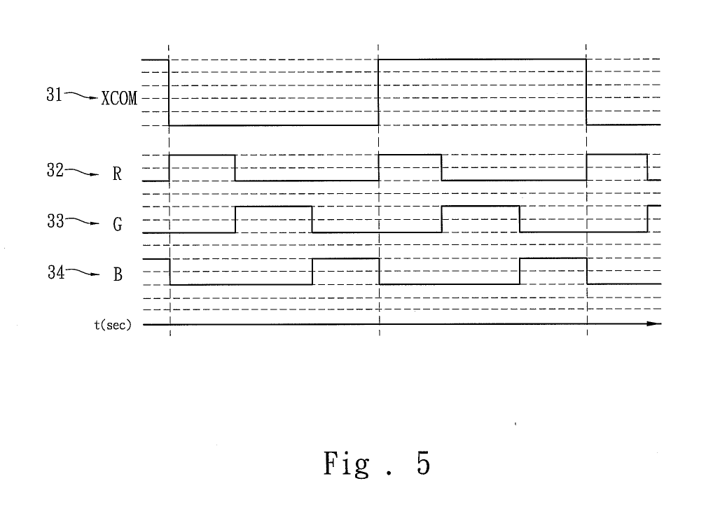

Refer to FIG. 5. The first segment voltage signal 211, the second segment voltage signal 212, the third segment voltage signal 213 and the fourth segment voltage signal 214 are input to the multicolor backlight modulation device 30 and modulated therein to form a common voltage signal 31 (XCOM) and a plurality of synchronous color-separation backlight driving signals 32, 33 and 34, wherein the number of the color-separation backlight driving signals is equal to the number of the backlights. The color-separation backlight driving signals 32, 33 and 34 are input to the multicolor modulation backlight unit 40 and respectively drive the backlight source 41 to generate backlights of different colors. The common voltage signal 31 and the segment voltage signals are respectively input to the common electrode 11 and the segment electrodes 12.

Below is described the driving method of the present invention. Firstly is prepared a monochromatic LCD panel 10, a single-level driver 20, a multicolor backlight modulation device 30, and a multicolor modulation backlight unit 40.

Next, the single-level driver 20 sequentially generates a plurality of segment voltage signals according to the timing, wherein the segment voltage signals are programmable with software.

Next, the segment voltage signals are input to the multicolor backlight modulation device 30 and modulated therein to form a common voltage signal 31 and a plurality of synchronous color-separation backlight driving signals 32, 33 and 34, wherein the number of the color-separation backlight driving signals is equal to the number of the backlight sources 41 (There are three colors in the drawing).

Next, the color-separation backlight driving signals 32, 33 and 34 are input to the multicolor modulation backlight unit 40. The common voltage signal 31 and the segment voltage signals are respectively input to the common electrode 11 and the segment electrodes 12.

Then, the common voltage signals 31 cooperate with the segment voltage signals to form voltage differences. The voltage differences turn on or turn off a mono-pixel 13 in a time-division mode. At the same time, the backlight source 41 generates backlights of different colors. The time-division different-color backlights are accumulated by vision persistence to present a multicolor effect on the mono-pixel 13.

It should be mentioned particularly: The color-separation backlight driving signals 32, 33 and 34 enable the mono-pixel 13 to emit different colors at different time intervals, and the time intervals of the color-separation backlight driving signals 32, 33 and 34 can be programmably varied. Therefore, the ratio of the time intervals of RGB backlights corresponding to the color-separation backlight driving signals 32, 33 and 34 can also be programmably varied. Thus, the resultant color of the mono-pixel 13 is also programmable.

Refer to FIG. 2. The single-level driver 20 is programmed to generate segment voltage signals. Therefore, the segment voltage signals may also be programmed to enable the multicolor backlight modulation device 30 to generate a driving voltage signal to drive an external device 50, such as a buzzer. Thus increase the applications of the present invention.

In the present invention, the segment voltage signals are programmed to control the ratio of RGB backlights generated by the multicolor modulation backlight unit 40. Therefore, the present invention can be programmed with software to expand its applications, such as a red backlight for alarm, or diversified backlights to promote recognition.

What is claimed is:

1. An intelligent row- and multicolor backlight-modulation liquid crystal display device comprising
a monochromatic LCD (Liquid Crystal Display) panel having a common electrode and a plurality of segment electrodes, wherein said common electrode and said segment electrodes are respectively arranged on an upper layer and a lower layer;
a single-level driver programmed to generate a plurality of segment voltage signals;
a multicolor modulation backlight unit having a backlight source emitting at least two different-color backlights; and
a multicolor backlight modulation device receiving said segment voltage signals and modulating a portion of said segment voltage signals to generate a common voltage signal and a plurality of synchronous color-separation backlight driving signals, wherein the number of said color-separation backlight driving signals is equal to the number of said backlights, and wherein said color-separation backlight driving signals are used to drive said multicolor modulation backlight unit, and wherein said common voltage signal and said segment voltage signals are respectively input to said common electrode and said segment electrodes.

2. The intelligent row- and multicolor backlight-modulation liquid crystal display device according to claim 1, wherein said monochromatic LCD panel has a plurality of mono-pixels corresponding to coincidence points of said common electrode and said segment electrodes.

3. The intelligent row- and multicolor backlight-modulation liquid crystal display device according to claim 2, wherein said common voltage signal cooperates with said segment voltage signals to form voltage differences driving said mono-pixels.

4. A row- and multicolor backlight-modulation method for a liquid crystal display device comprising steps:
preparing a monochromatic LCD (Liquid Crystal Display) panel having a common electrode and a plurality of segment electrodes, wherein said common electrode and said segment electrodes are respectively arranged on an upper layer and a lower layer;
preparing a multicolor modulation backlight unit having a backlight source emitting at least two different-color backlights;
preparing a single-level driver programmed to generate a plurality of segment voltage signals according to the timing;
preparing a multicolor backlight modulation device receiving said segment voltage signals and modulating a portion of said segment voltage signals to generate a common voltage signal and a plurality of synchronous color-separation backlight driving signals, wherein the number of said color-separation backlight driving signals is equal to the number of said backlights; and
using said color-separation backlight driving signals to drive said multicolor modulation backlight unit, and respectively inputting said common voltage signal and said segment voltage signals to said common electrode and said segment electrodes.

5. The row- and multicolor backlight-modulation method for a liquid crystal display device according to claim 4, wherein said monochromatic LCD panel has a plurality of mono-pixels corresponding to coincidence points of said common electrode and said segment electrodes.

6. The row- and multicolor backlight-modulation method for a liquid crystal display device according to claim 5, wherein said common voltage signal cooperates with said segment voltage signals to form voltage differences driving said mono-pixels.
